(19) United States
(12) Patent Application Publication
(10) Pub. No.: US 2016/0375729 A1
(43) Pub. Date: Dec. 29, 2016

(54) Tread Band Having Curved Blocks with Sipes

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventor: Shuichi KANEKO, Tokyo (JP)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 15/104,854

(22) PCT Filed: Dec. 15, 2014
(86) PCT No.: PCT/EP2014/077716

§ 371 Date: Jun. 15, 2016

(30) Foreign Application Priority Data
Dec. 17, 2013 (FR) 1362804

(51) Int. Cl. B60C 11/12; B60C 11/03; B60C 11/00

(52) U.S. Cl. CPC B60C 11/1204; B60C 11/0083; B60C 11/0302; B60C 11/0306; B60C 11/1259; B60C 2011/0374; B60C 2011/1268

(57) ABSTRACT

The disclosure concerns a tread band for a tire, said tread band having two sides with a predetermined distance D between these two sides and a centre. Indeed the tread band has a plurality of blocks, each block extending continuously in a curved manner to one side of the tread band towards the centre of this tread band with no groove separating this block in different parts, the block following a certain curvature C. All or part of the blocks of the plurality of blocks include a main sipe extending in the block and following the same curvature C, this sipe separating the block in two half parts.

### CROSS-REFERENCE TO RELATED APPLICATIONS

This application is a 371 national phase entry of PCT/EP2014/077716, filed 15 Dec. 2014, which claims the benefit of French Patent Application No. 1362804, filed 17 Dec. 2013, the contents of which are incorporated herein by reference for all purposes.

### BACKGROUND

The present disclosure relates to a pneumatic tire suitable for ice-bound or snow covered roads, and more particularly to a pneumatic tire for ice-bound or snow covered roads, in which the tread band of the pneumatic tire comprises a plurality of curved blocks.

Document U.S. Pat. No. 4,057,089 discloses a pneumatic tire comprising a tread band. The tread band has a plurality of blocks. Each block extends continuously in a curved manner to one side of the tread band towards the centre of this tread band. More particularly, the blocks are curved along structural curvature of a parabola of the second order. In the tread band of the document U.S. Pat. No. 4,057,089, the curved blocks are linked to a central strip. Indeed, the curved blocks are quite large. Thus, the rigidity of the curved blocks is important, and consequently the wear of the tread band is also important.

It is an object of the present disclosure to improve the durability of a tread band comprising a plurality of curved blocks.

“Tire” is understood as any type of elastic tire whether it is subjected to an internal pressure or not.

“Tread” of a tire is understood as a quantity of rubber material defined by lateral surfaces and by two principal surfaces, one thereof being designed to come into contact with a road surface when the tire is travelling.

“Block” is understood as relief element limited by some grooves. Each block comprises a plurality of lateral faces and a contact face which is able to come into contact with the road when the tire is rolling.

“Side of the tread band” is understood as the place in the pneumatic tire where a transition of the tread band with a side of the pneumatic tire occurs.

“Groove” is understood as a cut-out, the material faces thereof not coming into contact in normal travelling conditions. Generally, the width of a groove is greater than or equal to 2 mm.

“Sipe” is understood as a cut-out, the material faces thereof coming into contact during normal travelling conditions. Generally, the width of a sipe is less than 2 mm.

### SUMMARY

The disclosure relates to a tread band for a tire, said tread band comprising two sides with a predetermined distance D between these two sides and a centre. The tread band comprises a plurality of blocks. Each block extending continuously in a curved manner to one side of the tread band towards the centre of this tread band with no groove separating this block in different parts, the block following a certain curvature C. All or part of the blocks of the plurality of blocks comprises a main sipe extending in the block and following the same curvature C, this sipe separating the bloc in two ½ parts.

The main sipe makes the rigidity of the curved block decreasing. Consequently, the wear of the curved block is also decreasing too. Indeed, as the main sipe separates the curved block in two ½ parts, the rigidity of the two parts is globally the same, making the wear of the block uniform.

In a variant, the block comprises a plurality of secondary sipes, each secondary sipe extending perpendicularly to the main sipe.

The rigidity of the curved block is decreasing.

In a variant, the pitch between the plurality of secondary sipes is globally equal along the main sipe.

The uniformity in the wear of the block is improved.

In a variant, each block having lateral walls, or the secondary sipes do not extend until one of the lateral walls of the block.

We avoid the propagation of cracks inside the block.

In a variant, the main sipe having a depth of main sipe and the secondary sipes having the depth of secondary sipes, the depth of the secondary sipes is different than the depth of the main sipe.

Thus it is possible to adjust more precisely the rigidity in the block.

### BRIEF DESCRIPTION OF THE DRAWINGS

Other features and advantages of the disclosure will emerge from the following description, given by way of non-limiting example, with reference to the attached drawings in which:

FIG. 1 schematically depicts a part of a tread band according to the disclosure;

FIG. 2 schematically depicts a block of the tread band of FIG. 1 according to a second embodiment of the disclosure.

### DETAILED DESCRIPTION

In the description that follows, elements that are substantially identical or similar will be denoted by identical references.

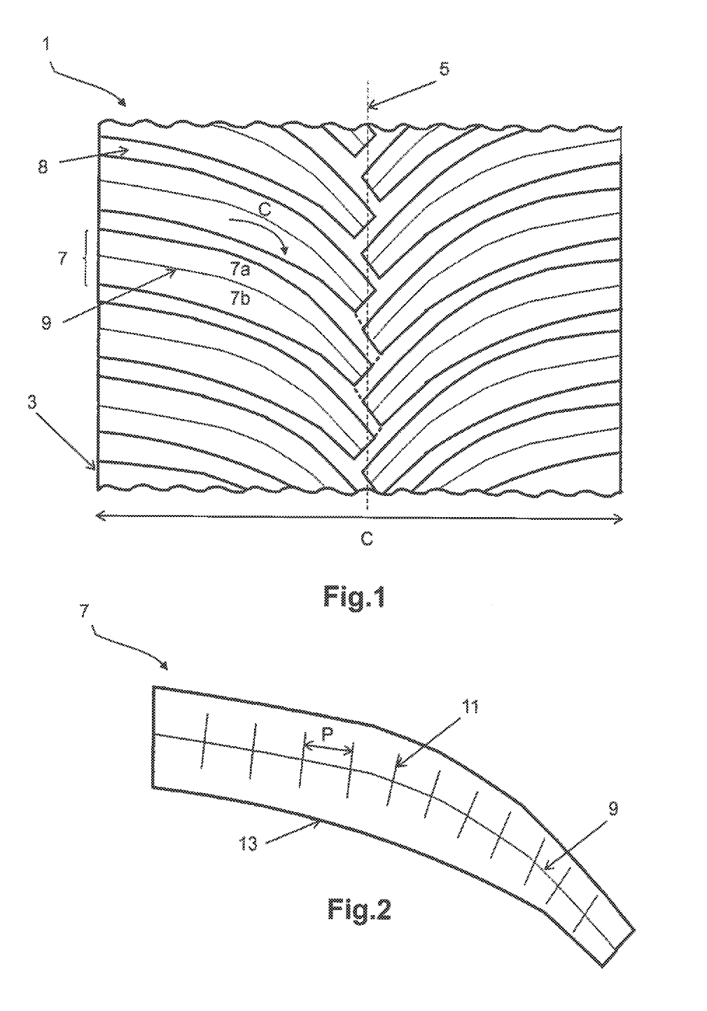

FIG. 1 depicts a tread band 1 made of rubber-like material for a tire. The tread band 1 comprises two sides 3 and centre 5. The distance D between the two sides 3 of the tread band is disclosed by the European Tire and Rim Technical Organisation (ETRTO). The ETRO defines this distance D such as D=(1.075−0.005 ar)*S^{1.001}, where ar is the Nominal aspect ratio and S is the Design Section Width on Measuring Rim. The tread band has a plurality of blocks 7 defined by main grooves 8. Each block 7 extends continuously in a curved manner to one side 3 of tread band towards the centre 5, the block following a certain curvature C. By “continuously”, it is understood that no secondary groove opening into the main grooves 8 separate the block in different parts. With no secondary groove opening into the main grooves, the evacuation of the water outside this tread band, via the main grooves 8, is not disturbed. By “towards the centre”, it is understood that the block stops at the level of the centre, or just before the centre or just after the centre. The centre means a line extending in a circumferential direction and dividing the tread band in two equally part of the tread bands.

More particularly, all the blocks 7 comprise a main sipe 9 extending in the block and following the same curvature C. The sipe 9 separates the block in two ½ parts 7a, 7b, this two ½ parts 7a, 7b being globally the same.

FIG. 2 schematically depicts a block of the tread band of FIG. 1 according to a second embodiment of the disclosure. In this embodiment, the block 7 comprises a plurality of secondary sipes 11. Each secondary sipe extends perpendicularly to the main sipe. The depth of the secondary sipes is globally equal to the depth of the main sipe. In a variant, the depth of the secondary sipes is different than the depth of the main sipe. For example, the depth of the secondary sipes is lower than the depth of the main sipe. All the combinations of depth between the main sipe and the secondary sipes are possible.

Indeed, the pitch P between the secondary sipes is globally equal along the main sipe.

In addition, the secondary sipes do not extend until one of the lateral walls of the block 7.

The disclosure is not restricted to the examples described and depicted and various modifications can be made thereto without departing from its scope.

1. A tread band for a tire, comprising:
two sides with a predetermined distance D between these two sides and a center,
a plurality of blocks, each of the plurality of block extending continuously in a curved manner to one side of the tread band towards the center, with no groove separating the block in different parts, the block following a certain curvature C,
wherein all or part of the blocks of the plurality of blocks include a main sipe extending in the block and following the same curvature C, the sipe separating the block in two half parts.

2. The tread band according to claim 1, wherein the block comprises a plurality of secondary sipes, each of the plurality secondary sipes extending perpendicularly to the main sipe.

3. The tread band according to claim 2, the pitch between the plurality of secondary sipes is globally equal along the main sipe.

4. The tread band according to claim 1, wherein each of the plurality of blocks has lateral walls, and the secondary sipes do not extend until one of the lateral walls of the block.

5. The tread band according to claim 1, wherein the main sipe has a depth of main sipe and the secondary sipes have the depth of secondary sipes, and the depth of the secondary sipes is different than the depth of the main sipe.
